(19) United States
(12) Patent Application Publication
(10) Pub. No.: US 2022/0292897 A1
(43) Pub. Date: Sep. 15, 2022

(54) SMART CHARGING DOOR LOCK

(71) Applicant: Royce Newcomb, Fresno, CA (US)

(72) Inventor: Royce Newcomb, Fresno, CA (US)

(21) Appl. No.: 17/694,583

(22) Filed: Mar. 14, 2022

Related U.S. Application Data
(60) Provisional application No. 63/160,797, filed on Mar. 13, 2021.

(51) Int. Cl. G07C 9/00

(52) U.S. Cl. CPC G07C 9/0069; E05B 47/0001

(57) ABSTRACT

One embodiment provides a charging door lock system that includes a door lock jamb connected with a first electrical component that provides a power source, and a combination unit that includes one or more rechargeable batteries. A locking bolt is connected to the combination unit. The locking bolt is integrated with a second electrical component that receives power from the power source for charging the one or more rechargeable batteries.

### CROSS-REFERENCE TO RELATED APPLICATIONS

This application claims priority to the U.S. provisional patent application serial number 63/160,797 filed on Mar. 13, 2021, which is incorporated herein by reference in its entirety.

### FIELD

The present embodiments relate to electronic door locks, and in more particular, to powering and charging of electronic door locks and video doorbells that are integrated with electronic door locks.

### BACKGROUND

Conventional electronic door locks or smart door locks all use batteries for powering the locking mechanism. When the batteries lose too much charge or die, the user may be locked out unless they carry a backup key, which typically is only used for emergencies and not carried by the user. This is the number one issue in the whole electronic door lock industry as to why more people do not want, will not use, or have a fear of using electronic door locks.

### SUMMARY

One embodiment provides a charging door lock system that includes a door lock jamb connected with a first electrical component that provides a power source, and a combination unit that includes one or more rechargeable batteries. A locking bolt is connected to the combination unit. The locking bolt is integrated with a second electrical component that receives power from the power source for charging the one or more rechargeable batteries.

Another embodiment provides a charging system for a smart door lock that includes a first electrical component that provides a power source through a door lock jamb. One or more rechargeable batteries are disposed within the smart door lock. A locking bolt includes a second electrical component that receives power from the power source for charging the one or more rechargeable batteries. The locking bolt is electrically connected to the smart door lock.

These and other features, aspects and advantages of the embodiments will become understood with reference to the following description, appended claims and accompanying figures.

### BRIEF DESCRIPTION OF THE DRAWINGS

The accompanying figures, which are incorporated herein, form part of the specification and illustrate one or more embodiments. Together with the description, the figures further explain the principles of the embodiments and to enable a person skilled in the relevant arts to make and use the embodiments.

FIG. 1 shows a latch bolt with electrical contacts for an electronic door lock mechanism, according to some embodiments.

FIG. 2 shows a door frame lock jamb with electrical contacts for connecting with and charging the electronic door lock mechanism of FIG. 1, according to some embodiments.

FIG. 3A shows an internal view of a door jamb showing the elements of FIGS. 1 and 2, according to some embodiments.

FIG. 3B shows an internal view of a charging mechanism within a door jamb along with electrical contacts for an electronic door lock mechanism, according to some embodiment.

FIG. 4 shows a perspective view of an example installed smart electronic door lock device, according to some embodiments.

FIG. 5A shows an internal view of a door frame jamb inductive charging device for charging an electronic door lock through the deadbolt of the electronic door lock, according to some embodiments.

FIG. 5B shows an internal view of a door frame jamb inductive charging device for charging the electronic door lock through the deadbolt that includes an internal mating inductive coil, according to some embodiments.

Although the specific features of the embodiments are shown in some drawings and not in others. This is done for convenience only, as each feature may be combined with any or all the other features in accordance with the embodiments herein.

### DETAILED DESCRIPTION

In the following detailed description, a reference is made to the accompanying drawings that form a part hereof, and in which the specific embodiments that may be practiced is shown by way of illustration. These embodiments are described in enough detail to enable those skilled in the art to practice the embodiments and it is to be understood that the logical, mechanical, and other changes may be made without departing from the scope of the embodiments. The following detailed description is therefore not to be taken in a limiting sense.

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The word “exemplary” is used herein to mean “serving as an example, instance, or illustration.” Any embodiment described herein as “exemplary” is not necessarily to be construed as preferred or advantageous over other embodiments. Likewise, the term “embodiments ” does not require that all embodiments include the discussed feature, advantage or mode of operation.

Various terms are used to refer to particular system components. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct communication between two or more elements, whether or not those elements are in physical contact with one another. Thus, if a first device couples to a second device, that connection may be through a direct connection or through an indirect connection via other devices and connections. The coupling can occur through two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely.

The terminology used herein is for the purpose of describing particular example embodiments only and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

The embodiments relate to powering and charging of electronic door locks and video doorbells that are integrated with electronic door locks. One embodiment provides a charging door lock system that includes a door lock jamb connected with a first electrical component that provides a power source, and a combination unit that includes one or more rechargeable batteries. A locking bolt is connected to the combination unit. The locking bolt is integrated with a second electrical component that receives power from the power source for charging the one or more rechargeable batteries.

Another embodiment provides a charging system for a smart door lock that includes a first electrical component that provides a power source through a door lock jamb. One or more rechargeable batteries are disposed within the smart door lock. A locking bolt includes a second electrical component that receives power from the power source for charging the one or more rechargeable batteries. The locking bolt is electrically connected to the smart door lock.

Some embodiments include a smart door lock (or smart video door locks integrated with a video doorbell) device that charges (e.g., one or more rechargeable batteries) via the insertion of the dead bolt latch into its strike and box. A built-in electronic circuit automatically charges the smart door lock device while the door that the smart door lock device is installed in is in a closed position (the majority of the time). In one or more embodiments, the smart door lock device is hardwired by a 12V power through original construction by connecting with doorbell wiring or new wiring, and then stepped down by a 6V transformer.

One or more embodiments charges the smart door lock device via inductive charging plates to provide power once the door that the smart door lock is installed in is closed. Some embodiments may use wiring using designed-in circuitry, a voltage regulator, and available power source (e.g., from a 12V doorbell power source; stepped down to 6V).

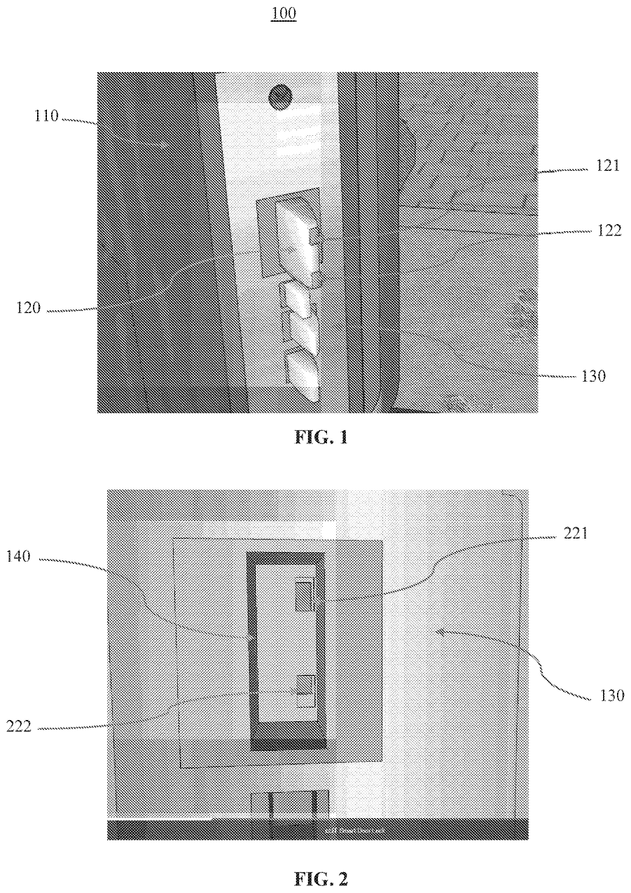

FIG. 1 shows a latch-bolt (or deadbolt) 120 with electrical contacts (negative electrical (receiving) contact 121, positive electrical (receiving) contact 122) for an electronic door lock device 100 mechanism, according to some embodiments. The electronic door lock device 100 is installed in a typical door 110 and also includes an electrical door hand-set lock set 130. Some embodiments provide continuous charging of the electric door lock set 130 by way of the negative electrical contact 121 and positive electrical contact 122 in the door latch (e.g., deadbolt or latch set/latch bolt) to power contacts in the door jamb. In one or more embodiments, the negative electrical contact 121 and positive electrical contact 122 may be disposed: at the ends of the latch-bolt (or deadbolt) 120, on one or both sides, or on one or both of the top/bottom of the latch-bolt (or deadbolt) 120. In some embodiments, the components of the electronic door lock device 100 mechanism are part of a high end lock set including: the electrical door hand-set lock set 130 including multiple bolts, hardened steel bolts; standard key-operated mechanical lock set connected to a motor driven device, a manual turn dial for opening and latching the latch-bolt (or deadbolt) 120 once a digital (touch, press switch, etc.) or mechanical push-button code is entered for providing opening of the latch-bolt (or deadbolt) 120, etc.

FIG. 2 shows a door frame lock jamb 140 with electrical contacts jamb negative electrical (source) contact 221 and jamb positive electrical (source) contact 222 for connecting with and charging one or more rechargeable batteries (through wires connected to circuitry or directly to the one or more batteries or battery holder/cartridge, battery unit, etc.) within the electronic door lock device 100 mechanism of FIG. 1, according to some embodiments. In some embodiments, the door frame lock jamb 140 is incorporated in or adapted to a door frame jamb strike plate 130. The jamb negative electrical contact 221 and the jamb positive electrical contact 222 in the door frame jamb 140 may be spring loaded, flexible, etc., types of contacts to ensure that an electrical connection or contact is always maintained with the negative electrical contact 121 and positive electrical contact 122 (FIG. 1), regardless of variation in gaps between the latch-bolt (or deadbolt) 120 and the door frame lock jamb 140 (or latch-bolt/deadbolt receiver). In some embodiments, one or more contact sensors may be implemented that switch off or disable electrical charging when the latch-bolt (or deadbolt) 120 opens (unlocked position) to prevent any potential for even a low voltage shock or low voltage contact of another electrical device (or user). In one or more embodiments, the jamb negative electrical contact 221 and the jamb positive electrical contact 222 are connected to a 6V power supply/source that may be dropped down from a preexisting 12V doorbell circuit wiring or an added new 12V wired supply (e.g., from solar, a new electrical circuit, etc.). In some embodiments, the existing doorbell wiring may be routed internally through the wall to a door jamb, or external to the wall and back into a portion of the wall near the doorjamb. In one or more embodiments, where the door is a double door and the lock jamb is between the two doors, the wiring may be routed externally to the door that remains fixed most of the time (e.g., over the door within conduits, in decorative covers, under the door plate and up from the bottom of the door and then routed to the jamb through a drilled opening, through a long drilled hole in the door (using a very long drill bit), etc.).

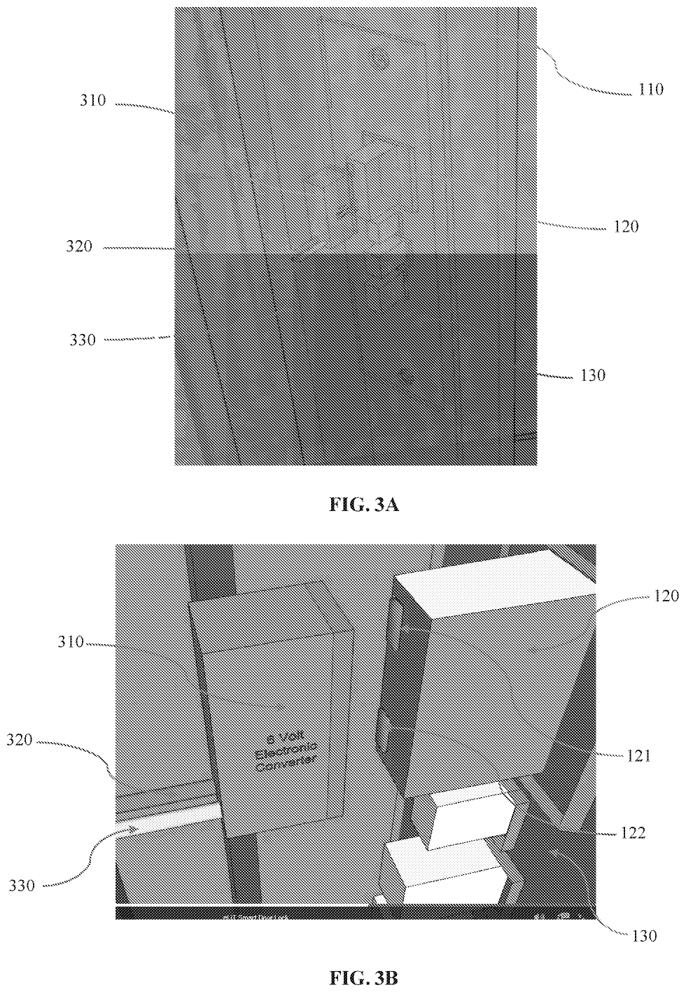

FIG. 3A shows an internal view of a door frame jamb showing the elements of FIGS. 1 and 2, according to some embodiments. As shown, the door 110 is closed and the latch-bolt (or deadbolt) 120 is in the locked position with the negative electrical contact 121 and positive electrical contact 122 connecting with the congruent jamb negative electrical contact 221 and the jamb positive electrical contact 222 within a door frame jamb latch-bolt (or deadbolt) receiver that houses the latch-bolt (or deadbolt) 120 for locking and preventing the door from opening. The negative electrical line 320 is connected to the jamb negative electrical contact 221, and the positive electrical line 330 is connected to the jamb positive electrical contact 222 through the door frame jamb electrical contact charger 310. In some embodiments, the negative electrical line 320 and the positive electrical line 330 are connected to a power source, such as existing doorbell wiring or a newly connected 12V source either dropped down to 6V by a transformer or stepped down to 6V via an internal transformer integrated within the door frame jamb electrical contact charger 310.

FIG. 3B shows an internal view of a charging mechanism within a door jamb along with jamb negative electrical contact 221 and the jamb positive electrical contact 222 that connect with the negative electrical contact 121 and positive electrical contact 122 for an electronic door lock device 100 mechanism, according to some embodiment. As shown, the door frame jamb electrical contact charger 310 (fixed to the door jamb) includes a junction, housing or cover. In some embodiments, the door frame jamb electrical contact charger 310 includes the negative electrical line 320 and the positive electrical line 330 that would be connected externally to the door frame jamb electrical contact charger 310. In one or more other embodiments, the negative electrical line 320 and the positive electrical line 330 are connected internally within the door frame jamb electrical contact charger 310. In some embodiments, instead of negative electrical line 320 and the positive electrical line 330 being wires, connectors that snap together that include connections may be implemented for ease of installation.

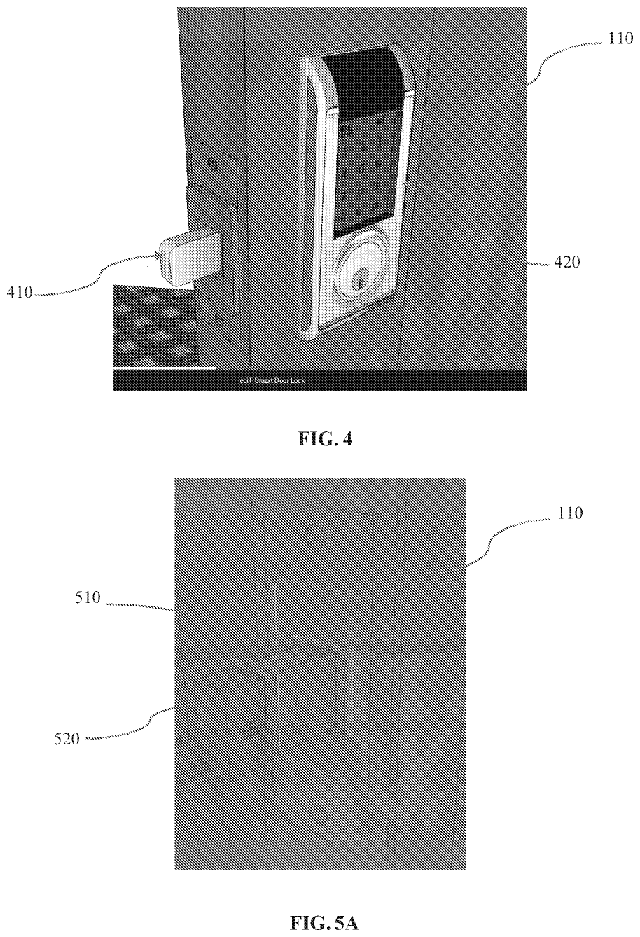

FIG. 4 shows a perspective view of an example installed smart electronic door lock device (or combination unit) 420 within the door 110, according to some embodiments. In some embodiments, the smart electronic door lock device 420 includes a latch-bolt (or deadbolt) 410, which is similar to the latch-bolt (or deadbolt) 120 (FIG. 1). As with the embodiments described above (and below), one or more embodiments include a high-end electrical door lock including: a) one or more internal rechargeable batteries for continuous charging (while the door is in a locked state with the negative electrical contact 121 (FIG. 3B) and positive electrical contact 122 (FIG. 3B) of the latch-bolt (or deadbolt) 410 connecting with the jamb negative electrical contact 221 (FIG. 2) and the jamb positive electrical contact 222 (FIG. 2) of the door frame jamb electrical contact charger 310 (FIGS. 3A-B)) to power the locking mechanism (e.g., motorized actuator, etc.) when line power is interrupted; b) a companion app that communicates signals or packets wirelessly (e.g., Wi-Fi, BLUETOOTH®, cellular, etc.) for a smart phone/tablet/computer for programing (user unlocking/locking pass-codes, temporary assigned pass-codes (e.g., different combination for a house-sitter that can be disabled when not needed without changing the main lock pass-code combination for the owner; set expiration date or time of day(s), which may be repeated, such as a housekeeper that used a code on Mondays and Fridays, the pass-code can be limited to those days and particular time periods during the day/night), deleting pass-codes, reporting periodicity, etc.), controlling (remote opening/locking) and providing status (when opened, when closed, interrupted power, battery life, etc.) for the smart electronic door lock device 420, which includes circuitry for a transceiver or receiver and transmitter and other electronic components (e.g., memory, one or more processors, etc.); c) facial recognition via a camera included within the smart electronic door lock device 420 for automated unlocking, or use of other biometric recognitions (fingerprint, retinal scan, etc.); d) temporary security token supplied to authorize a guest to unlock (e.g., for use from that authorized guest's smart phone).

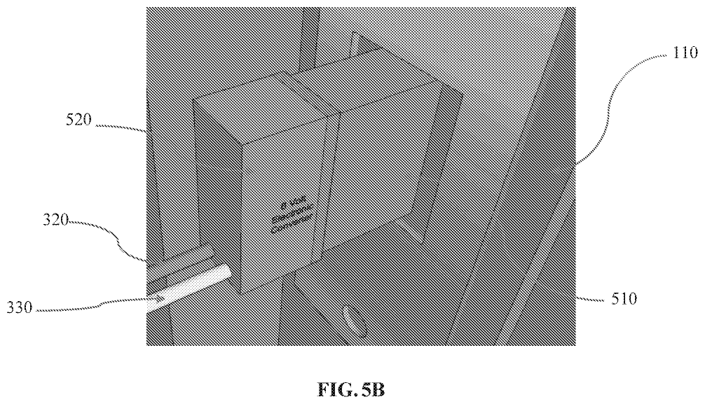

FIG. 5A shows an internal view of a door frame jamb inductive charging (source) device 520 for charging an electronic door lock device 100 (FIG. 1) or 420 (FIG. 4) through the latch-bolt (or deadbolt) 510 of the electronic door lock, according to some embodiments. In some embodiments, inductive charging of an electric door lock set makes use of the door frame jamb inductive charging (source) device 520 in a door jamb that supplies power to a matching inductive receiver or mating inductive coil in the latch-bolt (or deadbolt) 510. With inductive charging of the one or more batteries in the electronic door lock device 100 (FIG. 1) or 420 (FIG. 4), no contact is necessary for the latch-bolt (or deadbolt) 510 through positive and negative contacts.

FIG. 5B shows an internal view of the door frame jamb inductive charging device 520 for charging the electronic door lock device 100 (FIG. 1) or 420 (FIG. 4) through the latch-bolt (or deadbolt) 510 that includes an internal receiver or mating inductive coil, according to some embodiments.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the foregoing written description of the embodiments enables one of ordinary skill to make and use what is considered presently to be the best mode thereof, those of ordinary skill will understand and appreciate the existence of variations, combinations, and equivalents of the specific embodiments, method, and examples herein. The embodiments should therefore not be limited by the above-described embodiments, method, and examples, but by all embodiments and methods within the scope and spirit as claimed.

What is claimed is:

1. A charging door lock system, comprising:
a door lock jamb coupled with a first electrical component that provides a power source;
a combination unit including one or more rechargeable batteries; and
a locking bolt coupled to the combination unit, the locking bolt being integrated with a second electrical component that receives power from the power source for charging the one or more rechargeable batteries.

2. The system of claim 1, wherein the first electrical component comprises a positive source contact and a negative source contact, the second electrical component comprises a positive receiver contact and a negative receiver contact, the positive source contact removably couples with the positive receiver contact, and the negative source contact removably couples with the negative receiver contact.

3. The system of claim 2, wherein the positive source contact and the negative source contact are one of spring loaded or flexible contact components.

4. The system of claim 1, wherein the first electrical component comprises a source inductive component, and the second electrical component comprises a receiving inductive component.

5. The system of 4, wherein the source inductive component and the second conductive component are contactless with one another and provide the power source inductively for charging the one or more rechargeable batteries.

6. The system of claim 1, wherein the first electrical component receives power from a hardwired electrical source through coupling to doorbell wiring.

7. The system of claim 1, wherein the combination unit unlocks a door using programmed combinations, and one or more contact sensors are coupled to the door lock jamb or the locking bolt to switch electrical charging off upon the locking bolt being positioned in an unlocked position.

8. The system of claim 7, wherein the combination unit unlocks a door using biometrics.

9. The system of claim 7, wherein the biometrics comprises one or more of: facial recognition using an integrated camera of the combination unit, retinal recognition using the camera, or fingerprint recognition using the camera.

10. The system of claim 7, wherein the combination unit wirelessly communicates with an app installed on a smart device or computing device, the app: communicates status information, receives programming information, provides for remote controlled opening and locking of the locking bolt by communicating signals for actuating a locking actuator device coupled to the locking bolt and integrated in the combination unit, and provides a signals for a temporary security token for an authorized guest user to unlock the locking bolt.

11. A charging system for a smart door lock, comprising:
a first electrical component that provides a power source through a door lock jamb;
one or more rechargeable batteries disposed within the smart door lock; and
a locking bolt comprising a second electrical component that receives power from the power source for charging the one or more rechargeable batteries, the locking bolt being electrically coupled to the smart door lock.

12. The system of claim 11, wherein the first electrical component comprises a positive source contact and a negative source contact, the second electrical component comprises a positive receiver contact and a negative receiver contact, the positive source contact removably couples with the positive receiver contact, and the negative source contact removably couples with the negative receiver contact.

13. The system of claim 12, wherein the positive source contact and the negative source contact are one of spring loaded or flexible contact components.

14. The system of claim 11, wherein the first electrical component comprises a source inductive component, and the second electrical component comprises a receiving inductive component.

15. The system of 14, wherein the source inductive component and the second conductive component are contactless with one another and provide the power source inductively for charging the one or more rechargeable batteries.

16. The system of claim 11, wherein the first electrical component receives power from a hardwired electrical source through coupling to doorbell wiring.

17. The system of claim 11, wherein the smart door lock unlocks a door using programmed combinations, and one or more contact sensors are coupled to the door lock jamb or the locking bolt to switch electrical charging off upon the locking bolt being positioned in an unlocked position.

18. The system of claim 17, wherein the smart door lock unlocks a door using biometrics.

19. The system of claim 17, wherein the biometrics comprises one or more of facial recognition using an integrated camera of the smart door lock, retinal recognition using the camera, or fingerprint recognition using the camera.

20. The system of claim 17, wherein the smart door lock wirelessly communicates with an app installed on a smart device or computing device, the app: communicates status information, receives programming information, provides for remote controlled opening and locking of the locking bolt by communicating signals for actuating a locking actuator device coupled to the locking bolt and integrated in the combination unit, and provides a signals for a temporary security token for an authorized guest user to unlock the locking bolt.
